(19) United States
(12) Patent Application Publication
(10) Pub. No.: US 2023/0321546 A1
(43) Pub. Date: Oct. 12, 2023

(54) PREDICTIVE AUDIO REDACTION FOR REALTIME COMMUNICATION

(71) Applicant: Modulate, Inc., Cambridge, MA (US)

(72) Inventors: William Carter Huffman, Cambridge, MA (US); Joshua D. Fishman, Dorchester, MA (US); Zachary Nevue, Providence, RI (US)

(21) Appl. No.: 18/132,251

(22) Filed: Apr. 7, 2023

Related U.S. Application Data
(60) Provisional application No. 63/329,128, filed on Apr. 8, 2022.

(51) Int. Cl. A63F 13/67; G10L 15/187; G10L 15/197; G10L 15/22; G06F 21/60

(52) U.S. Cl. CPC A63F 13/67; G10L 15/187; G10L 15/197; G10L 15/22; G06F 21/604; G10L 2015/088

(57) ABSTRACT

Illustrative embodiments employ trained artificial intelligence to provide real-time (e.g., zero introduced latency), or near-real-time (e.g., less than 500 ms of introduced latency), moderation of a verbal communication, without the need for human moderators.

By using predictive technology with pre-defined knowledge of undesirable content (e.g., speech to be redacted from a verbal communication), undesirable content of a verbal communication (e.g., human speech or text-to-speech communication) may be censored, as the verbal communication is created. Prediction of undesirable content may be based on context of the initial audio communication (e.g., words preceding the offensive language) and/or the phonetic content of the verbal communication preceding the undesirable content, and/or the phonetic content of the undesirable content itself (e.g., the first sounds of offensive language).

### PRIORITY

This application claims priority to U.S. Provisional Patent Application No. 63/329,128, filed on Apr. 8, 2022, entitled “PREDICTIVE AUDIO REDACTION FOR REALTIME COMMUNICATION,” and naming William Carter Huffman, Joshua Fishman, and Zachary Nevue as inventors, the contents of which are hereby incorporated by reference in their entirety.

### FIELD

Illustrative embodiments of the present invention generally relate to moderating audio signals.

### BACKGROUND

Realtime voice chat communication is an essential part of the social experience in gaming communities. Real-time voice/audio communication can be essential for social gaming.

For example, players in online multiplayer games use voice to strategize and convey tactical information, but also for socialization—meeting new players, catching up with friends, etc.

Game studios implement voice chat in their online multiplayer games to encourage socialization and deepen interaction between players on their platform, increasing engagement and enjoyment from the players. As the scale of modern social gaming increases, millions of conversations may be ongoing simultaneously on online platforms.

Undesirably, however, some users may use toxic, disruptive, or even dangerous language on the platform. Examples of undesirable terms/audio may include swear words and slurs, disruptive noises, and personal identifying or sensitive information, among other things. Consequently, game communities can also be venues for disruptive or toxic behavior, including abusive language, harassment, child safety issues, and other harms.

Voice chat increases the risk and severity of harassment through its more immersive medium and greater depth of expression than textual communication. Voice may also reveal demographic information about the players (age, perceived gender, etc.), increasing the risk of harm due to a player's age, gender, race, etc. Game studios combat toxic behavior arising in voice chat through moderation, particularly proactive moderation solutions that detect disruptive behavior and escalate it to moderators automatically.

Even with proactive voice chat moderation solutions, some types of harm cannot be fully prevented with conventional approaches. Particularly, situations where children or other players hearing explicit vocabulary cannot be eliminated by traditional moderation tools—even if other players using profanity can be warned or otherwise disciplined after the fact, the victim player has already been exposed to the content. Additionally, players, especially children, being tricked or coerced into revealing information about themselves such as phone number, address, where they go to school, usernames on social media, etc. puts them in danger that cannot easily be undone by post-facto moderation.

Game studios, players wishing to avoid these types of harm, and parents wishing to protect their children while gaming (both from exposure to profanity, and from revealing sensitive information about themselves), all benefit from preventing the dangerous voice content from being transmitted in the first place. Traditional methods to do this are similar to audio censorship on live television, where the audio stream is delayed by several seconds so that a censor can mute content before it is broadcast, if needed. However, this technique cannot apply effectively to real-time voice chat communication, because introducing significant amounts of latency into a real-time conversation disrupts the ability of participants to engage with each other.

### SUMMARY

Illustrative embodiments, provide a predictive audio redaction system and method configured to redact target speech from a verbal communication. Illustrative embodiments, discussed below (for example in the context of a gamer playing a video game on a computer or gaming console), receive an input audio buffer from a player speaking and produce an output audio buffer containing the player's recent speech, with some or all portions (i.e., “target speech”) redacted. Among other things, the system may include:
an input audio buffer that holds the player's recent speech,
a prediction engine (aka “prediction mechanism”) that consumes the player's recent speech and produces a prediction probability that the most recent player's speech is a portion of a dangerous speech segment (i.e., speech that should be redacted, such as a forbidden word, or identifying information), and
an output configured to filter a portion of the recent speech according to the prediction probability and a configurable threshold to produce an output audio buffer, in which some of the recent speech may be redacted.

One embodiment includes a computer-implemented method of moderating a verbal communication, the method comprising:
receiving at the computer, at a reception time (r1), an electronic speech signal of the verbal communication, said electronic speech signal of the verbal communication comprising a first portion at a first time (t1);
providing the electronic speech signal to an artificial intelligence, the artificial intelligence trained to:
   (1) process said first portion of the electronic speech signal and thereby predict target speech a time window (t2-t3), which time window (t2-t3) is subsequent to the first portion of the electronic speech signal, said target speech comprising a pre-defined set of terms to be redacted, and
   (2) redact said target speech from said electronic speech signal during said time window to produce a redacted verbal communication signal with less than 500 ms of introduced latency as measured from the reception time (r1);
producing the redacted verbal communication signal using the artificial intelligence; and
providing said redacted verbal communication signal from the artificial intelligence to a consumer.

In some such embodiments, receiving an electronic speech signal of verbal communication comprises receiving acoustic spoken speech at a transducer and converting said acoustic spoken speech to said electronic speech signal. In some such embodiments, the transducer comprises a microphone. Such a microphone may produce such an electronic speech signal in digital format.

In some embodiments, redacting said target speech from said electronic speech signal during said time window to produce the redacted verbal communication comprises:
muting the electronic signal during said time window.

In some embodiments, to predict target speech at a time window (t2-t3) comprises predicting said target speech before said target speech is generated. In some embodiments, to predict target speech at a time window (t2-t3) comprises predicting said target speech without recognizing a semantic meaning of the first portion of the electronic speech signal.

In some embodiments, the method is executed at a computer at which the verbal communication was generated. In other embodiments, the method is executed at a third computer of a third-party user, remote from a computer at which the verbal communication was generated, to mitigate the risk of the third-party hearing the target speech. In other embodiments, the method is executed at an intermediary computer system (e.g., in the cloud) electronically disposed between (i) a computer at which the verbal communication was generated and (ii) a computer in use by a third party, to mitigate the risk of the third-party hearing the target speech.

In some embodiments, each term in the pre-defined set of terms to be redacted is defined by a set of phones, and not based on a meaning of said term.

In some embodiments, the verbal communication comprises artificially-generated speech. In other embodiments, the verbal communication comprises human speech uttered audibly by a human into a transducer.

Another embodiment provides a computer-implemented system for moderating a verbal communication, the system comprising:
a communications interface configured to receive, at a reception time (r1), an electronic speech signal of the verbal communication, said electronic speech signal of the verbal communication comprising a first portion at a first time (t1);
an artificial intelligence trained to:
   (1) process said first portion of the electronic speech signal and thereby predict target speech at a time window (t2-t3), which time window (t2-t3) is subsequent to the first portion of the electronic speech signal, said target speech comprising a pre-defined set of terms to be redacted, and
   (2) redact said target speech from said electronic speech signal during said time window to produce a redacted verbal communication signal with less than 500 ms of introduced latency as measured from the reception time (r1); and
a system output interface configured to provide the redacted audible communication signal as system output.

In some embodiments, the communications interface comprises the system output interface.

In some embodiments, to predict target speech at a time window (t2-t3) comprises predicting said target speech before said target speech is generated. In some embodiments, to predict target speech at a time window (t2-t3) comprises predicting said target speech without recognizing a semantic meaning of the first portion of the electronic speech signal.

Some illustrative embodiments are implemented as a computer program product having a computer usable medium with computer readable program code thereon. The computer readable code may be read and utilized by a computer system in accordance with conventional processes.

Yet another embodiment includes a non-transitory computer-readable medium storing computer-executable code thereon, the code when executed by a computer causing the computer to execute a process of moderating a verbal communication, the code comprising:
code for causing the computer to receive, at a reception tie (r1) an electronic speech signal of the verbal communication, said electronic speech signal of the verbal communication comprising a first portion at a first time (t1);
code for processing the electronic speech signal with an artificial intelligence, to:
   (1) process the first portion of the electronic speech signal and thereby predict target speech at a time window (t2-t3), which time window (t2-t3) is subsequent to the first portion of the electronic speech signal, said target speech comprising a pre-defined set of terms to be redacted, and
   (2) redact said target speech from said electronic speech signal during said time window to produce a redacted verbal communication signal with less than 500 ms of introduced latency as measured from the reception time (r1);
code for causing the artificial intelligence to produce the redacted verbal communication signal; and
code for providing said redacted verbal communication signal to a consumer.

In some embodiments, code for processing the electronic speech signal with an artificial intelligence to predict target speech at a time window (t2-t3) comprises: code for predicting target speech before said target speech is generated. In other embodiments, code for processing the electronic speech signal with an artificial intelligence to predict target speech at a time window (t2-t3) comprises: code for predicting target speech before said target speech without recognizing a semantic meaning of the first portion of the electronic speech signal.

In some embodiments, each term in the pre-defined set of terms to be redacted is defined by a set of phones, and not based on a semantic meaning of said term.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1A schematically illustrates an embodiment of system including one or more embodiments of a computer-implemented method of moderating a verbal communication;

FIG. 1B schematically illustrates an embodiment of a speech signal and a version of said speech signal that has had a portion of said speech signal redacted;

FIG. 2 schematically illustrates an embodiment of a system configured to moderate verbal communications;

FIG. 3 is a flow chart of an embodiment of a method moderating a verbal communication;

FIG. 4 is a flow chart of an embodiment of a method moderating a verbal communication.

### DETAILED DESCRIPTION

Illustrative embodiments employ trained artificial intelligence to provide real-time (e.g., zero introduced latency), or near-real-time (e.g., less than 500 ms of introduced latency), moderation of a verbal communication, without the need for human moderators. Illustrative embodiments redact target speech from a verbal communication, without disrupting benign conversation by mistakenly redacting innocent vocabulary (a false positive).

At the scale of modern social gaming, millions of conversations may be ongoing simultaneously, necessitating an automated solution instead of human intervention.

By using predictive technology with pre-defined knowledge of undesirable content (e.g., speech to be redacted from a verbal communication), undesirable content of a verbal communication (e.g., human speech or text-to-speech communication) may be censored, as the verbal communication is created. Prediction of undesirable content may be based on context of the initial audio communication (e.g., words preceding the offensive language) and/or the phonetic content of the verbal communication preceding the undesirable content, and/or the phonetic content of the undesirable content itself (e.g., the first sounds of offensive language).

In some embodiments, censorship may be achieved without analyzing the meaning of the audio, through the use of phone and/or phoneme analysis. A phone, as used in phonetics and linguistics, is a distinct sound or gesture not specific to any language or meaning of a word. For example, a user may say “what the f-” and the presence of the “f” phone in conjunction with the phones of “what the,” even if not analyzed for meaning, may indicate subsequent undesirable audio. Illustrative embodiments of the present invention may censor the audio following the content indicating undesirable audio.

Some embodiments, predict target speech without recognizing a semantic meaning of a portion (e.g., a first portion) of an electronic speech signal. In other illustrative embodiments, the meaning and context of the speech may be analyzed to censor (e.g., redact) target speech. For example, a user may say “what the” and an embodiment of the present invention may analyze that phrase for its meaning to determine target speech is likely to follow that phrase. Illustrative embodiments may then censor the audio subsequent to “what the” and before the generation or transmission of the word or phones predicted to follow the “what the.”

As another example, a pre-defined set of target speech may specify that the phrase “son of a witch” is to be redacted, and a redaction mechanism may be configured (e.g., trained) to redact that phrase. Some embodiments identify that phrase within a verbal communication by analyzing phones and/or phonemes within an electronic version of the verbal communication, without identifying or analyzing a semantic meaning of the phrase.

Other embodiments, however, identify that phrase within a verbal communication by recognizing the semantic meaning of a sub-portion of the phrase. For example, some embodiments identify the phrase as target speech by recognizing a subset of the words in the phrase. For example, some embodiments identify the phrase as target speech by recognizing the words “son of a” and redacting the phrase upon making that recognition. Other embodiments identify the phrase as target speech by recognizing fewer words, such as the words “son of” or even “son.”

Illustrative embodiments also store, or are configured to know, how much of an electronic speech signal 140 is to be redacted in order to redact the target speech. For example, a given item of target speech may have an associated time value, and illustrative embodiments will redact a portion of the electronic speech signal 140 having a length of that associated time. Other embodiments begin redacting a portion of the electronic speech signal 140 predicted to include the target speech, and monitor the speech signal until detecting within the electronic speech signal 140 the occurrence of a term (or phone or phoneme) that indicates the end of (or completion of the generation of) the target speech 141. For example, upon detecting target speech including “son of a,” embodiments may redact speech from the electronic speech signal 140 until detecting the term “witch,” as which point said embodiments will stop redacting.

It should be noted that, in some embodiments, undesirable speech (i.e., target speech) is not limited to human spoken words, but may also include non-word audio, artificially-generated speech such as AI generated audio, and text-to-speech audio, among other things. A list of undesirable terms/audio may be generated by one or more of individual users, game studios, among others.

Definitions: As used in this description and the accompanying claims, the following terms shall have the meanings indicated, unless the context otherwise requires.

The term “introduced latency” means delay added to a signal due to processing of the signal to assess the signal and redact a portion or portions of this signal.

The term “ms” means milliseconds.

A “phone” is a speech sound, as would be understood from the fields of phonetics or linguistics.

A “phoneme” is a speech sound in a given language that, if swapped with another phoneme, could change one word to another, as would be understood from the fields of phonetics or linguistics.

A “set” includes at least one member.

The term “target speech” is speech (e.g., a set of words and/or phrases) to be redacted from a verbal communication. A set of words and/or phrases that make up target speech may be defined by a user of a computer, or a third-party administrator. Words or phrases in target speech may include, without limitation, profanity (e.g., swear words); epithets; insults; and sensitive personal information. Sensitive personal information may include, for example, a person's social security number, address, bank account number, a password, etc. Target speech may be referred to as “undesirable speech” in that it is speech to be redacted from a verbal communication.

The term “verbal communication” means communication expressed in words of a language. In some embodiments, a verbal communication may be generated by a human utterance. Such a human utterance may be converted to an electronic speech signal by a transducer such as a microphone or vibration sensor. In some embodiments, a verbal communication may be generated from text by text-to-speech software. Such text-to-speech software may generate a verbal communication in the form of an electronic speech signal without first generating the verbal communication as an audio signal.

Illustrative embodiments improve over conventional technology by automating the processing of a signal and redacting a portion or portions of the signal. Illustrative embodiments remove subjective human judgment from the process of processing of a signal and redacting a portion or portions of the signal. Illustrative embodiments also reduce, and in some embodiments eliminate, delaying a speech signal while processing the speech signal and redacting a portion or portions of the signal.

Conventional technology for censoring a portion of a signal involves delaying the signal, perhaps by may seconds, to allow a human listener to catch undesirable language and engage an apparatus to prevent transmission or broadcast of that undesirable language. Such conventional technology is known from the art of broadcast television, in which an audio signal (and corresponding video signal) is delayed by several seconds, and a human listener (which human listener may be thought of as a censor), exercising his or her subjective judgement, listens to the audio signal before that audio signal is broadcast, identifies undesirable language, and censors that undesirable language from being broadcast (this may be thought of as censoring the audio signal), while allowing the remaining audio signal (i.e., the part of the audio signal that is not undesirable language) to be broadcast. For example, such a system may replace undesirable language in the audio signal with a “bleep” sound.

Such conventional technology suffers from one or more shortcomings. For one, it relies on subjective human judgement to determine what language is undesirable language to be censored. A human censor may miss a term or phrase that might be undesirable language that should be censored, and/or may censor a term or phrase that should not be censored. Illustrative embodiments mitigate or even eliminate that problem by replacing the subjective human judgment with automated artificial intelligence.

For another, it relies on human reaction time to implement the censoring operation. That human reaction time, which is much longer than a computer's reaction time, adds latency to the audio signal. Such latency is particularly disruptive to communications from one party to another, when events occurring contemporaneously with the communication rely on speedy communication. For example, latency may reduce or even destroy the value of a spoken communication or command from a gamer playing a fast-moving action game on a computer or gaming console to a teammate playing on a remote computer or console. For example, a gamer's spoken warning to a teammate to “look out” or a spoken command to “get that guy” would be useless if delayed to the point that the remote teammate did not receive the spoken warning or command speech until it is too late to avoid an undesirable outcome (e.g., by failing to “look out” or by failing to “get that guy”). In that context, that problem may arise with a delay (e.g., caused by introduced latency added by a redaction system) of equal to or greater than 500 milliseconds (“ms”).

Illustrative embodiments improve over conventional technology by processing of a signal and redacting a portion or portions of the signal without introducing significant latency, and in some embodiment without adding any latency, to the signal. For example, illustrative embodiments operate to redact undesirable language from a signal with introduced latency of less than 500 ms, or less than 250 ms, or less than 200 ms, or less than 100 ms, or even less than 50 ms. Some illustrative embodiments operate to redact undesirable language from a signal without any introduced latency (i.e., zero latency).

### Overview of Some Embodiments

Illustrative embodiments, provide a predictive audio redaction system and method configured to redact target speech from a verbal communication. Illustrative embodiments, discussed below (for example in the context of a gamer playing a video game on a computer or gaming console), receive an input audio buffer from a player speaking and produce an output audio buffer containing the player's recent speech, with some or all portions (i.e., “target speech”) redacted. Among other things, the system may include:
an input audio buffer that holds the player's recent speech,
a prediction engine (aka “prediction mechanism”) that consumes the player's recent speech and produces a prediction probability that the most recent player's speech is a portion of a dangerous speech segment (i.e., speech that should be redacted, such as a forbidden word, or identifying information), and
an output configured to filter a portion of the recent speech according to the prediction probability and a configurable threshold to produce an output audio buffer, in which some of the recent speech may be redacted.

In some situations, the prediction mechanism and output may be combined into one model or mechanism accomplishing both goals and producing both prediction confidences and output audio buffers simultaneously. The system is configurable to select for a desired latency (i.e., the time delay between when any speech content appears in the output buffer compared to when it appears in the input buffer) and for a desired coverage (given a piece of content that is desired be redacted, the minimum percentage of that piece of content that should be redacted in the output buffer). The prediction mechanism receives as input a set of parameters that configure it to accurately predict the presence of content to be redacted. The system may be configured for latency and coverage through explicit input values, or implicitly through the prediction mechanism parameters. Further, the latency and/or coverage parameters may instead be dynamic bounded ranges of acceptable latency and/or coverage values, which the output can use to optimize at runtime for minimal latency and/or maximal coverage under a prediction mechanism confidence constraint.

The accuracy of the prediction mechanism may be increased by including additional inputs that it is parameterized to consume. These inputs may include a summary of previous speech by the player in various forms (transcript, list of or distribution over previous phonemes, neural embeddings, etc.), including short-term summaries (e.g., previous speech in the same phrase or sentence, or the previous sentence) and long-term summaries (e.g., a general summary of the previous ten minutes of speech, or hour of speech, or the trend of the character of speech over a long duration). The inputs may also include summaries of other players in the game (such as their speech, actions, performance, etc.), information about what type of game is being played, the state of the game (and the state of the game with respect to the player—e.g., is the player winning or losing), the current topic of conversation or previous conversations, histories of the players in the chat session (including previous reports of the players or moderation actions taken against them), demographic information (estimated or known) of the speaking player and/or other players in the voice chat session (such as age, gender, etc.), or other relevant information to predicting the likelihood of dangerous speech.

The prediction mechanism which produces a probabilistic estimation of whether the recent speech is a portion of a dangerous speech segment may produce the probabilistic estimation in a variety of forms, such as a single floating point prediction value, an array of values representing predictions at certain offsets into the output buffer (i.e., a mask), Boolean or integer values, etc. The prediction mechanism may be combined with the output to directly produce the output audio buffer (with potentially redacted speech) and avoiding an explicit representation of the prediction probability—in this case, the prediction probability is implied by whether the speech in the output buffer has been modified in comparison with the input buffer or not. The redaction of speech in the output buffer is typically achieved by muting the audio that is a portion of dangerous speech (i.e., setting the audio sample values to zero); but may also be achieved by replacing or overlaying the speech with a tone, music, or other sound (including modification of the initially spoken word, such as replacing the word “spoon” with “spool”)—or even by filtering the speech, such as changing the sound of the speaker's voice, etc.

The predictive audio redaction system may be configured implicitly (through the prediction mechanism parameters) to redact a predetermined set of words, phrases, or sequences of words; or the system may be configured explicitly to redact a customizable set of words, phrases, or sequences of words. For example, the system may be configured by a parent of a child playing an online multiplayer game to redact (among other content) the sequence of words corresponding to the child's phone number or address, or the specific word or words corresponding to the child's username on a social media platform. Or, the system may be implicitly configured by the game studio by parameterizing the prediction mechanism to redact a single profane word or one of a list of profane words; or an entire class of content such as phone numbers, full names, addresses, etc. The word/phrase/sequence of words or set thereof to be redacted may be configured by spelling them, providing one or more phonetic spellings, providing example sentences or phrases in which the word is used, recording one or more spoken pronunciations of the word, or other methods of communication. Additionally, if using implicit configuration through parameterizing the prediction mechanism, the word/phrase/sequence of words or collection thereof may be specified through the format of the training data used to produce the parameterization (for example, by marking instances of a word to be redacted as “true” and words that are not to be redacted as “false”). Further non-word content may also be specified (such as screaming, shouting, obscene noises, music, etc.) to be redacted through mechanisms such as specifying examples of the target sounds, specifying a pre-determined list of such sounds that are identifiable by the prediction mechanism (e.g., included during the training procedure and explicitly labeled then), or other specification methods.

The predictive audio redaction system may also include a time-warping error correction system. This time-warping error correction system includes a buffer of recently redacted speech and mistake prediction mechanism. The time-warping error correction system receives as input the recent speech from the speaker, the predictive audio redaction system's output audio buffer, and the predictive audio redaction system's redaction decisions (e.g., as a buffer of recent predictions from its prediction mechanism, etc.), and outputs an error-corrected output audio buffer. The time-warping error correction system processes the redaction decisions and determines whether a mistaken redaction occurred. If no mistaken redaction has occurred, it passes through the output audio buffer from the predictive audio redaction system unchanged as the error-corrected output audio buffer. If a mistaken redaction has occurred, the time-warping error correction system time-warps the input audio that was redacted (or a portion of it) to temporally compress it into a smaller duration and producing an error-correct speech segment, and includes that in place of the redaction in the error-corrected output audio buffer, potentially delaying subsequent non-redacted speech by an additional error-correction latency amount, in order to accommodate the error corrected speech segment preceding it. In this way, the time-warping error correction system re-introduces mistakenly redacted content at the expense of slightly distorting the content (by speeding it up) and slightly delaying subsequent non-redacted content. The time-warping error correction system may also time-warp subsequent non-redacted content in order to decrease the latency introduced by the error correction back to zero.

Some of the configuration values for the predictive audio redaction system, such as the parameterization of the prediction mechanism, may be determined through a training procedure, such as a machine learning training procedure—in which case the prediction mechanism may be a machine learning model. The training procedure includes a set of data including examples of spoken content that include examples of the content to be redacted and examples of spoken content that do not include examples of the content to be redacted. The presence of content to be redacted is explicitly labeled in some of the examples in the set of data, for example by providing timestamp ranges noting the time in the examples when content to be redacted is spoken. The set of data may be created by extracting examples and labels from a proactive voice chat moderation system or other moderation system, or may be produced through manual labeling of voice chat data, or through other means (such as synthesizing spoken examples from transcriptions, in which the transcripts themselves may be real or synthesized). The training procedure involves one or more iterations where the prediction mechanism produces candidate predictions of whether redaction should or should not occur. The candidate predictions are compared with the labels denoting whether redaction should or should not occur, and the parameters of the prediction mechanism are updated to more often predict a redaction corresponding to the labels and to less often predict a redaction that does not correspond to the labels. This training procedure may be done given an explicit set of some or all other system configurations, such as latency and coverage; or the training procedure may be done on a variety or range of other system configurations in order to allow specific values of those configurations to be input later; or the training procedure may be done in absence of those configurations, and the resulting accuracy of the prediction mechanism may under various conditions may be used to inform a choice of optimal values for some or all of the configurations.

Additionally, in some embodiments, the predictive audio redaction system may include a configuration tool that allows users to select appropriate configurations of the system given their performance requirements. The configuration tool may, for example, include a table showing precision and recall values across individual or all content to be redacted given various choices for latency and coverage, based on performance on a test data set (which may be collected in a similar way to the data set discussed in the training procedure). The configuration tool may also be an interactive system evaluates precision and recall dynamically given different input configurations, and may be used on a user's own input data (or may synthesize new data on the fly for testing). The configuration tool may additionally support determining performance (e.g., precision and/or recall) on new words/phrases/word sequences or sets thereof, or additional configurations such as including or omitting player history, demographics, other player interactions, game state, various choices of thresholds for the output, etc. as inputs to the predictive audio redaction system. The output of the configuration tool may be performance numbers (such as precision, recall, F-score, etc.), a simple binary “valid”/“invalid” determination based on an internal performance threshold (useful, for example, with end-user configurable settings such as using the predictive audio redaction system as a type of parental control for redacting phone numbers or other identifying information from voice chat).

In illustrative embodiments, an artificial intelligence (240) may be configured to produce a redacted verbal communication signal with less than a specified or desired introduced latency, for example when executed on specified target hardware, by limiting the number of terms in the target speech the artificial intelligence is trained to predict, and/or by limiting the number of layers in a neural network, to name but a few examples.

### Example

Illustrative embodiments may be demonstrated by the following specific example. Note that this example is not intended to limit all embodiments, although it may apply to some embodiments.

In this case, an example predictive audio redaction system could be used inside a voice chat framework's real-time audio callback operating on audio that a player is speaking before it is transmitted to a voice chat server for distribution, being given as input configurations such as a target latency of no more than 20 milliseconds, coverage of 75% or greater of the to-be-redacted content, confidence of greater than 90%, and a set of floating point vectors as parameterization of the prediction mechanism, consuming as input a 10 millisecond raw floating point linear pulse-code modulated (“PCM”) audio buffer and producing as output a 10 millisecond raw floating point linear PCM audio buffer. Other formats of audio are possible, such as signed 16 bit integer linear PCM audio, spectrogram representations of the audio, MFCC representations of the audio, Opus packets, etc.

The example predictive audio redaction system could use an internal circular buffer (e.g., input butter 250) to store the most recent 250 milliseconds of input speech, and use a multi-stage prediction mechanism to predict whether the 250 milliseconds of input speech contain portions of content (target content) that should be redacted as the most recent spoken content in the circular buffer.

The first stage of the prediction mechanism could be a phoneme extraction model, such as a support vector machine, or “SVM,” or neural network (such as a recurrent neural network, convolutional neural network, feedforward fully connected neural network, transformer, etc.) parameterized by model weight vectors, which produces an ordered sequence of distributions over phoneme probabilities representing the probabilities that each phoneme was spoken at the given time in the input audio buffer.

The sequence of phoneme distributions could be placed in the buffer 250 (or in another circular buffer) representing the distributions of spoken phonemes over the past five seconds at 100 millisecond intervals. A 4-gram word language model with a many-to-many word to phoneme sequence lexicon could be used, along with beam search decoding or other decoding methods, to produce a set of candidate sequences of likely spoken words and/or predictions of likely partially spoken or soon-to-be-spoken words. This language model could be reduced or distilled from a larger language model representing all speech in the given language, down to only entries which are relevant to the target words/phrases/sequences of words to be redacted (this reduction could happen when building the system for a static list of to-be-redacted content, or could happen dynamically at runtime with user-specified or dynamic to-be-redacted content).

The example predictive audio redaction system 200 may use the set of predictions to determine what words were most recently spoken (with associated confidences) and to predict what words are likely to be partially spoken. After this, the latency configuration may be applied to determine whether to-be-redacted content was in the process of being spoken at the delayed time—the point in time given by the current time minus the latency configuration number; and if so what confidence the prediction system gives to that content being to-be-redacted content. If to-be-redacted content is not currently being spoken, the 10 milliseconds audio content being spoken at and most recently previous to the delayed time is copied to the output buffer and returned unmodified. If to-be-redacted content is potentially being partially or fully spoken at the delayed time, system could determine how much of the redacted content has been spoken already, as a percentage of the full duration of that piece of to-be-redacted content. If that percentage is greater than or equal to the 100% minus the coverage percentage, and the confidence value that the content is to-be-redacted content is greater than the confidence threshold, the system would copy the input audio to the output audio buffer 260 in the same way as if to-be-redacted content is not currently being spoken, but additionally the system would redact (e.g., by setting the samples to zero) all of the audio samples in the output buffer 260.

In an alternative implementation, the prediction mechanism could be combined with the output and implemented as a single neural network that takes as input the content of the circular buffer 250 and produces as output a redacted version of that consent in the output buffer 260.

The neural network could be a recurrent or transformer model that takes as conditioning inputs the latency, coverage, and confidence parameters and produces an output audio buffer, potentially with redacted audio content. This neural network could be trained via machine learning end-to-end by synthesizing non-redacted and redacted audio pairs from training data, gathered e.g., by sampling audio from a proactive moderation system that estimates whether to-be-redacted content has been said post-facto. The neural network could also take as conditioning information (e.g., through vector embeddings, etc.) transcriptions of previous speech in the conversation by the player or other speakers, player history information, player demographic information, Boolean values indicating whether specific events (such as the player dying, the player winning, etc.) have occurred, or other contextual information. The neural network could also produce confidence information (for example, a floating-point value) on the estimated accuracy of its output buffer, again parameterized and learned through machine learning training.

An error correction mechanism could subsequently consume the content of the output audio buffer and confidence/prediction, along with the content of the input audio circular buffer 250 to form the predictive audio redaction system. If the error correction system detected, for example, a short sequence (e.g., less than 50 milliseconds—this value could also be configurable) of redaction followed by no further redaction for a short sequence (e.g., another 20 milliseconds, also potentially a configurable value), it could determine that the redaction was a mistake. It could then select from the input circular buffer the audio that had been redacted, use time warping (e.g., by converting to a spectrogram, shortening the time duration represented by the spectrogram, and then re-synthesizing back to raw audio) to compress the 50 milliseconds of speech which was mistakenly redacted down to 20 milliseconds and the 20 milliseconds not redacted down to 10 milliseconds). It could then, upon the next three times it is called, produce 10 millisecond buffers comprising (in order) the two 10 millisecond buffers of time-warped redacted speech followed by the 10 milliseconds of non-redacted speech. Each of the three times, in this example, it is next called on a 10 millisecond input buffer, and for one additional call, it could time-warp the input 10 millisecond buffers down to 5 milliseconds and store those in a circular buffer, producing in the output audio buffer (in order) two time-warped 5 millisecond segments for each 10 millisecond audio buffer input. After four such calls, all previous time-warped audio would have been consumed and output, and the error correction mechanism would cease time-warping and buffering, and return to simply returning the input audio unmodified (until a new redaction error is detected). In this way, the error correction mechanism ensured that all spoken audio was transmitted (albeit distorted somewhat through time-warping) without permanently increasing the latency in the conversation.

### Some Illustrative Embodiments

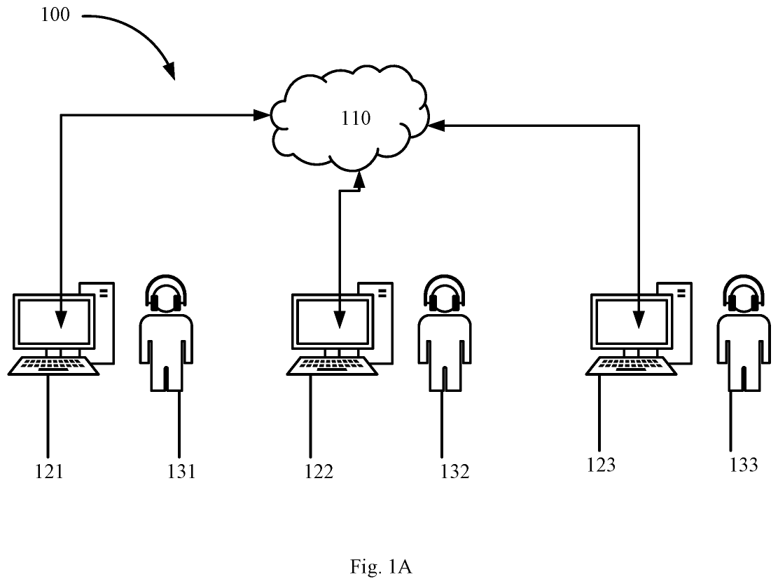

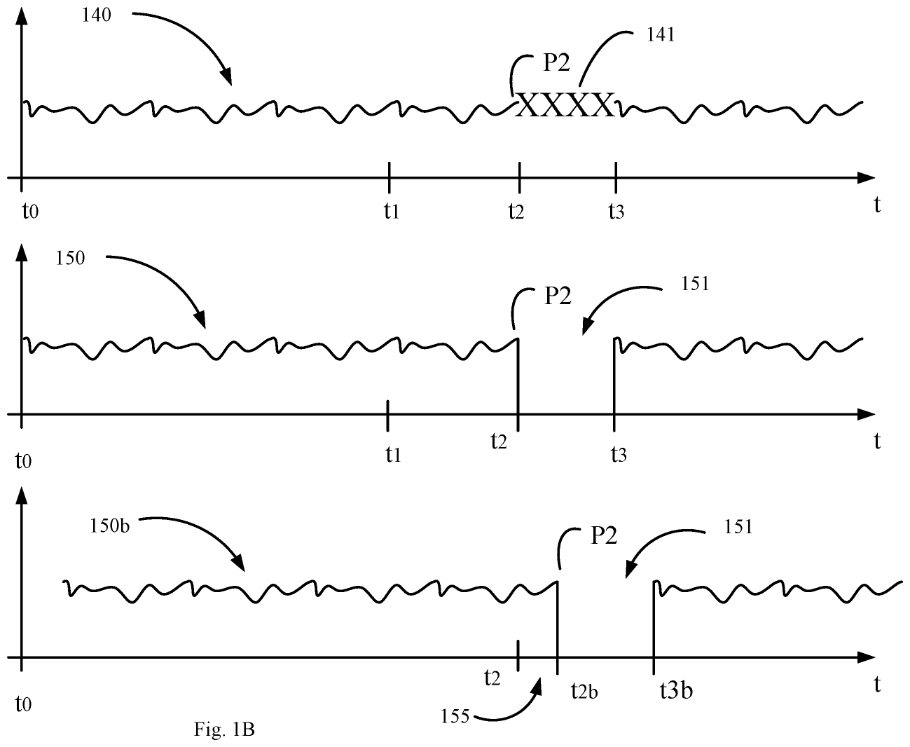

FIG. 1A schematically illustrates an embodiment of system 100 implementing one or more embodiments of a computer-implemented method of moderating verbal communications. In some embodiments, the system 100 may be a network of gaming systems in which each computer 121, 122, 123 is a gaming console, and each corresponding operator 131, 132, 133 is a gamer. In some embodiments, the system 100 may be a network of computers in a work environment in which each computer 121, 122, 123, and each corresponding operator 131, 132, 133 is a worker or computer operator. The computers 121, 122, 123 are coupled to one another via a network 110, which may be a wide area network (“WAN”), and local area network (“LAN”), or the internet, to name but a few examples.

In illustrative embodiments, one or more of the computers 121, 122, 123 includes an audio input device by which it may receive audio input (e.g., speech) from its corresponding operator 131, 132, 133. For example, one or more of the computers 121, 122, 123 may be coupled to a transducer (e.g., a boom microphone coupled to an operator's headset; or a vibration sensor, to name but a few examples).

As a first operator 131 speaks, audio input (e.g., the operator's verbal communications) is captured by the transducer and transformed (or transduced) into an electronic speech signal of that verbal communication. That electronic speech signal is then transmitted to one or both of the other operators 132, 133 via the network 110.

In some embodiments, the first computer 121 of the first operator 131 includes a system 200 that executes a method (300, 400) of moderating the verbal communication of the first operator 131 to redact or censor undesirable speech (“target speech”) within the verbal communication of the first operator 131.

For example, a curve in FIG. 1B schematically illustrates an electronic speech signal 140 of the verbal communication of the first operator 131, and the “XXXX” between time t2 and time t3 represents target speech 141 within that verbal communication. A censor, which may be the first operator 131, or another operator 132, 133, or a third party (e.g., a user of a computer system within the network 110) may desire to redact that target speech 141 from the electronic speech signal, to produce a redacted verbal communication signal 150.

In the redacted verbal communication signal 150, the target speech 141 has been removed or otherwise made so that the target speech 141 is not received, or is not hearable or intelligible by, another operator (e.g., 132, 133). For example, in some embodiments, the amplitude or digital values of the target speech 141 may be set to zero so that the target speech 141 is rendered inaudible, as schematically illustrated a portion 151 in redacted verbal communication signal 150. In other embodiments, the target speech 141 in electronic speech signal 140 of the verbal communication of the first operator 131 may be replaced, in the redacted verbal communication signal 150, by another sound, such as a “bleep,” a tone, or other sounds that does not communicate the target speech.

Some embodiments of methods and systems produce the redacted verbal communication signal 150 with zero introduced latency. For example, relative to the electronic speech signal 140, the redacted verbal communication signal 150 has zero latency, in that each point on the redacted verbal communication signal 150 occurs at the same time as its corresponding point in the electronic speech signal 140. Taking point P2 as an example, that point in the electronic speech signal 140 occurs at time t2, and that point in the redacted verbal communication signal 150 also occurs at time t2. In other words, the process of redacting the signal has added zero introduced latency. A redacted verbal communication signal 150 having zero latency may be produced, for example, by turning off a microphone at a point in the signal at which an artificial intelligence has predicted target speech will occur. A redacted verbal communication signal 150 having zero latency may be produced, for example, by switching a system output to a register holding all digital zeros at a point in the signal at which an artificial intelligence has predicted target speech will occur.

In contrast, some embodiments of methods and systems produce the redacted verbal communication signal 150 with some introduced latency. Taking point P2 as an example, that point in the electronic speech signal 140 occurs at time t2, but that point in the redacted verbal communication signal 150b also occurs at time t2b, which is slightly delayed from time t2. In other words, the process of redacting the signal has some introduced latency 155, defined as the difference between t2b and t2 (i.e., introduced latency=t2b−t2).

Illustrative embodiments produce a redacted verbal communication signal 150 with an introduced latency 155 of less than or equal to 250 ms, or 200 ms, or 100 ms, or even 50 ms; 20 ms, or 10 ms. Although some embodiments may be capable or producing a redacted verbal communication signal 150 with zero ms of introduced latency, other embodiments are capable of producing a redacted verbal communication signal 150 with a lower bound of 0.1 ms of introduced latency.

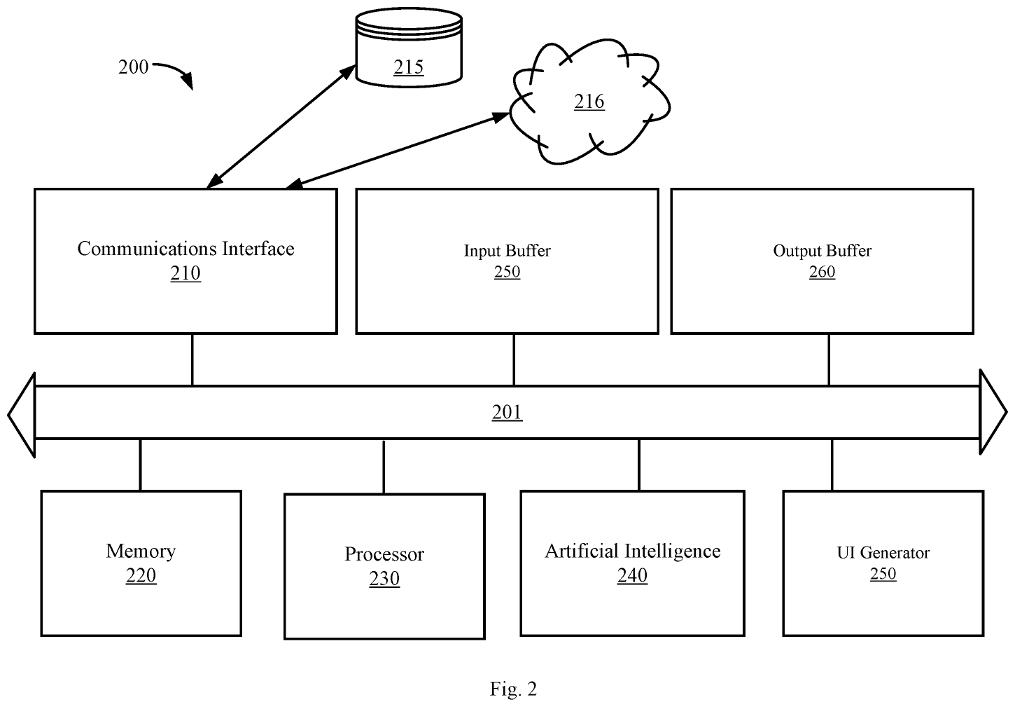

FIG. 2 schematically illustrates an embodiment of a computer-implemented system 200 configured to moderate verbal communications.

The system 200 includes a plurality of modules in communication with one another via a communications bus 201.

A communications interface 210 is configured to interface with external devices, such as a microphone to receive spoken speech from an operator (e.g., 331), and/or a database 215 which may store, for example, a listing of target speech 141 (terms to be redacted), and/or to couple to a set of computers over the network 216, which set of computers may store, for example, a listing of target speech 141.

The system 200 also includes a set of computer processors 230 configured to execute computer-executable code. The set of computer processors may include one or more microprocessors as known in the semiconductor arts, and may include one or more disposed in a cloud of computing resources.

Some embodiments also include a set of memories 220, which memories may be nonvolatile memories, and which may store computer code executable by the set of computer processors 230.

Some embodiments of a system 200 include an input buffer 250 (which may be a circular buffer) configured to store a portion or sub-portion of an electronic speech signal of a verbal communication. Such an electronic speech signal may be stored in a digital format.

Some embodiments of a system 200 include an output buffer 260 (which may be a circular buffer) configured to store a portion or sub-portion of a redacted verbal communication signal. Such redacted verbal communication signal may be stored in a digital format.

Some embodiments of a system 200 include a user interface generator 270 configured to produce a user interface to allow an operator of the system to provide user input to specify or adjust one or more operating parameters of the system 200. For example, for an artificial intelligence 240 configured to redact a plurality of terms from an electronic speech signal, such a user interface may allow the operator to specify that all of those terms should be redacted when the system operates on such an electronic speech signal, or that only an operator-specified subset of those terms should be redacted when the system operates on such an electronic speech signal.

The system 200 includes an artificial intelligence 240 configured (or “trained”) to (1) process a first portion of the electronic speech signal and thereby predict target speech a time window (t2-t3), which time window (t2-t3) is subsequent to the first portion of the electronic speech signal, said target speech comprising a pre-defined set of terms to be redacted, and (2) redact said target speech from said electronic speech signal during said time window to produce the redacted verbal communication signal. The artificial intelligence 240 may be referred-to as a “prediction mechanism.” Some embodiments predict the targets speech 141 before that target speech has been generated (e.g., before the target speech 140 is uttered by an operator, or artificially-generated). In some embodiments, the artificial intelligence 240 may be implemented in whole or in part by executable code executed by the computer processor 230.

The prediction mechanism may be a neural network (NN), such as a recurrent neural network, convolutional neural network, feedforward fully connected neural network, among others. The neural network may be parameterized by model weight vectors and produce an ordered sequence of distributions over phone/phoneme probabilities representing the probabilities that each phone/phoneme was spoken at a given time.

An illustrative embodiment utilizes a feed-forward convolutional neural network with 6 convolutional layers and 2 feed-forward layers, though those skilled in the art may appreciate that other numbers of layers are viable, perhaps depending on the quantity of target speech to be redacted, and/or the precision (as that term would be understood in the art of data science) and/or the recall (as that term would be understood in the art of data science) specified for a method or system.

The layers may operate on raw audio samples producing a floating-point probability of redactions. In illustrative embodiments, receptive fields in the neural network may range from 25 ms to 250 ms. Additional conditioning data inputs to the convolutional layers may be dependent on a rolling buffer of 20 distributions of detected phone/phoneme probabilities. Operation of the neural network pursuant to methods disclosed herein may produce a redacted communication signal with less than 500 ms or with less than 50 ms or less of induced latency.

The training procedure for a neural network involves one or more iterations where the prediction mechanism produces candidate predictions of whether redaction should or should not occur. The candidate predictions are compared with the labels denoting whether redaction should or should not occur, and the parameters of the prediction mechanism are updated to more often predict a redaction corresponding to the labels and to less often predict a redaction that does not correspond to the labels. This training procedure may be done given an explicit set of some or all other system configurations, such as latency and coverage; or the training procedure may be done on a variety or range of other system configurations in order to allow specific values of those configurations to be input later; or the training procedure may be done in absence of those configurations, and the resulting accuracy of the prediction mechanism may under various conditions may be used to inform a choice of optimal values for some or all of the configurations.

Some of the configuration values for a predictive redaction system, such as the parameterization of the prediction mechanism, may be determined through a training procedure, such as a machine learning training procedure—in which case the prediction mechanism may be a machine learning model. The training procedure includes a set of data including examples of spoken content (such as verbal communication) that include examples of target speech (which may be referred-to as “target content”) to be redacted and examples of spoken content that do not include examples of the content to be redacted. The presence of content to be redacted is explicitly labeled in some of the examples in the set of data, for example by providing timestamp ranges noting the time in the examples when content to be redacted is spoken. The set of data may be created by extracting examples and labels from a proactive voice chat moderation system or other moderation system, or may be produced through manual labeling of voice chat data, or through other means (such as synthesizing spoken examples from transcriptions, in which the transcripts themselves may be real or synthesized).

The artificial intelligence 240 may be configurable to select for desired coverage (e.g., the content to be redacted, minimum percentage of content that should be redacted, etc.). Other inputs may include a summary of players' previous speech in various forms (e.g., transcript, list or distribution of phones/phonemes, neural embeddings, etc.), summaries of other users in a game (e.g., their speech, actions, performance, etc.), information on the status of a game (e.g., if a player is losing), the current topic of conversation, histories of users in the chat (e.g., if a player has had moderator action in the past), demographic information of the users, among other things. The artificial intelligence 240 may be configurable, for example, by a computer operator 131 via input through a user interface generated by UI generator 250, and/or by pre-specified configuration data from a file stored in memory 220, or in remote database 215, or in a remote computer via network 216.

In some embodiments, the artificial intelligence may produce a probabilistic estimation of whether a specific sample of speech (words, phones, and/or phonemes) is a portion of, or precursor to, target speech (profanity (e.g., swear words), epithets, insults, sensitive personal information, etc.). Upon determining a probability of to-be-spoken target speech, based on a threshold probability/confidence the system may redact the subsequent target speech. A threshold probability/confidence required for redaction may be set implicitly to (e.g., by a game studio) to redact a predetermined set of target speech, or explicitly (e.g., by a user or third-party) to redact a customizable set of target speech.

Illustrative embodiments process a first portion of the electronic speech signal and produce the redacted verbal communication signal, as described above, with less than 500 ms of introduced latency as measured from the reception time (r1) at which the system received the electronic speech signal.

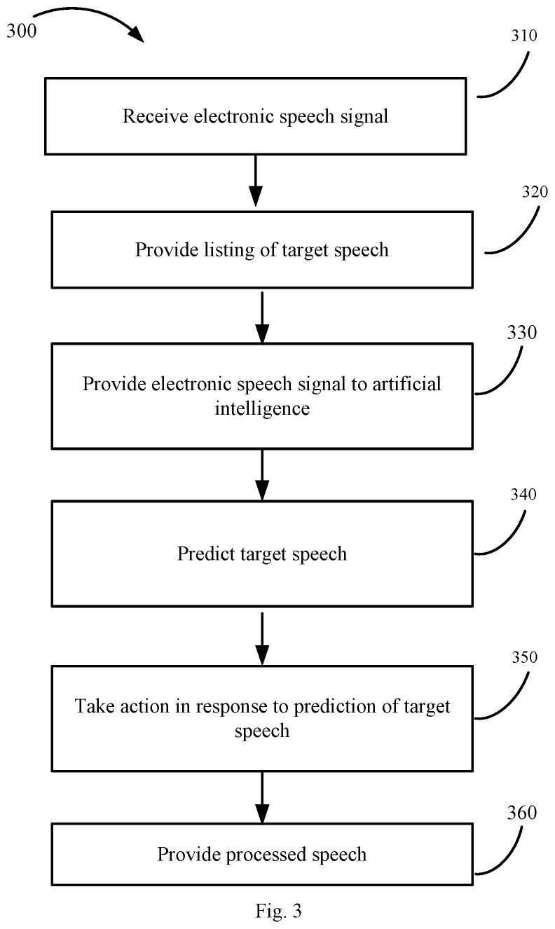

FIG. 3 is a flow chart of an embodiment of a method moderating a verbal communication.

Step 310 includes receiving, at a system 200 at a reception time, an electronic speech signal 140 of a verbal communication, the electronic speech signal having a first portion at a first time (e.g., at time t1) within the electronic speech signal. In some embodiments, the electronic speech signal is generated by a circuit comprising a transducer (e.g., a microphone; a vibration sensor), which transducer is disposed to receive, and does receive, an audio signal comprising the verbal communication generated by a human operator. In some embodiments, the electronic speech signal is generated by a circuit (e.g., a set of computer processors) executing text-to-speech software, where text of the verbal communication is provided to said circuit by a computer operator. In illustrative embodiments, the electronic speech signal is a digital signal.

In some embodiments, the electronic speech signal 140 of a verbal communication is stored in an input buffer 250 to await processing by the artificial intelligence 240 to produce the redacted verbal communication signal 150, 150b. In some embodiments, the redacted verbal communication signal 150, 150b is stored in the output buffer 260 to be made available to output, to a consumer (e.g., a user of another computer) via a system output. The communications interface may include such a system output.

Some embodiments include step 320, in which the system receives a listing or identification of target speech. In illustrative embodiments, an artificial intelligence 240 is configured to identify and redact a pre-determined list of words or phrases in target speech, and step 320 includes receiving, from an operator, specification that the system should redact all such target speech, or specification that the system should redact an operator-identified subset of such target speech. Some embodiments are configured to redact by default all such target speech that the artificial intelligence 240 is configured to identify and redact, unless a subset of such target speech is received or provided at step 320.

Step 330 includes providing the electronic speech signal of a verbal communication 140 to the artificial intelligence 240 for processing. In illustrative embodiments, the artificial intelligence is configured to, and does, process the first portion of the electronic speech signal 140 and thereby predict target speech, which target speech is during a time window (t2-t3), which time window (t2-t3) is subsequent to the first portion of the electronic speech signal.

Step 350 includes taking action in response to the prediction of the target speech. For example, in some embodiments, at step 350 the artificial intelligence 240 is configured to, and does, redact said target speech from said electronic speech signal 140 during said time window to produce a redacted verbal communication signal 150, 150b. In illustrative embodiments, the artificial intelligence 240 produces the redacted verbal communication signal 150, 150b with less than 500 ms of introduced latency as measured from the reception time. The target speech includes a pre-defined set of terms to be redacted.

Other embodiments may take alternative, or additional action at step 350. For example, where the operator that generated the target speech is a gamer (i.e., a computer operator operating a computer to play a game), some embodiments impose a penalty on that operator, for example by adding latency to that operator's input to the game, or removing an asset from that operator's game (e.g., health of the operator's character; speed of the operator's character, to name but a few examples).

At step 360, the method provides the redacted verbal communication signal 150, 150b, for example as a system output. Said output may be transmitted to a set of operators of a computer, e.g., operator 331, 332, and/or 333. Step 360 may be described as providing the redacted verbal communication signal 150, 150b from the artificial intelligence 240 to a consumer.

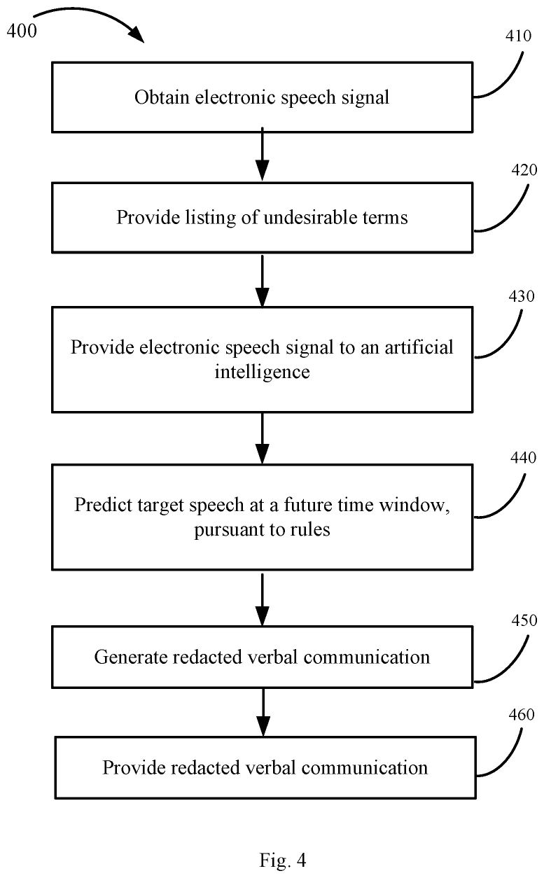

FIG. 4 is a flow chart of an embodiment of a method moderating a verbal communication pursuant to a set of rules. Such a method, and a system that performs such a method, improves over conventional technology at least by replacing subjective human judgment with objective, rule-based terminations.

Step 410 includes obtaining or receiving at a computer, at a reception time (r1), an electronic speech signal of the verbal communication, said electronic speech signal of the verbal communication comprising a first portion at a first time (t1).

Some embodiments include step 420, in which the system receives a listing or identification of target speech, as described in connection with step 320, above.

Step 430 includes providing an artificial intelligence 240 trained to process the electronic speech signal based on a set of rules, the rules defining target speech by a set of phones and/or phonemes, the artificial intelligence configured to:
(i) predict, based on the rules and as a function of phones or phonemes in the electronic speech signal, target speech at a time window (t2-t3), which time window (t2-t3) begins subsequent to the first time (t1), and to
(ii) redact said target speech from said electronic speech signal during said time window to produce a redacted verbal communication signal with less than 500 ms of introduced latency.

Step 440 includes predicting, based on the rules and as a function of phones or phonemes in the electronic speech signal, target speech at a time window (t2-t3), which time window (t2-t3) begins subsequent to the first time (t1).

Step 450 includes generating a redacted verbal communication via the artificial intelligence, by redacting said target speech from said electronic speech signal 140 during said time window to produce a redacted verbal communication signal 150, 150b with less than 500 ms of introduced latency.

Step 460 includes providing the redacted verbal communication signal 150, 150b, as a system output. Said output may be transmitted to a set of operators of a computer, e.g., operator 331, 332, and/or 333. Step 360 may be described as providing the redacted verbal communication signal 150, 150b from the artificial intelligence 240 to a consumer.

A listing of certain reference numbers is presented below.
100: Computer network;
110: Communications network (e.g., WAN; LAN; Cloud);
121: First computer;
122: Second computer;
123: Third computer;
131: First user;
132: Second user;
133: Third user;
140: Speech signal;
141: Undesirable terms;
150: Redacted verbal communication signal;
151: Location of redacted terms;
155: Introduced latency;
200: System;
201: Communications bus;
210: Communications interface;
215: Database;
216: Cloud resources;
220: Memory;
230: Computer processor;
240: Artificial intelligence;
250: Input buffer;
260: Output buffer;
270: User interface generator.

Various embodiments may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

Without limitation, potential subject matter that may be claimed (prefaced with the letter “P” so as to avoid confusion with the actual claims presented below) includes:
P1. A computer-implemented method of moderating a verbal communication, the method comprising:
   receiving at the computer, at a reception time (r1), an electronic speech signal of the verbal communication, said electronic speech signal of the verbal communication comprising a first portion at a first time (t1);
   providing the electronic speech signal to an artificial intelligence, the artificial intelligence trained to:
      (1) process said first portion of the electronic speech signal and thereby predict target speech a time window (t2-t3), which time window (t2-t3) is subsequent to the first portion of the electronic speech signal, said target speech comprising a pre-defined set of terms to be redacted, and
      (2) redact said target speech from said electronic speech signal during said time window to produce a redacted verbal communication signal with less than 500 ms of introduced latency as measured from the reception time (r1); and
   providing said redacted verbal communication signal from the artificial intelligence to a consumer.
P2. The method of P1, wherein receiving an electronic speech signal of verbal communication comprises receiving acoustic spoken speech at a transducer and converting said acoustic spoken speech to said electronic speech signal.
P3. The method of P2, wherein the transducer comprises a microphone.
P4. The method of any of P1-P3, wherein redacting said target speech from said electronic speech signal during said time window to produce the redacted verbal communication comprises:
   muting the electronic signal during said time window.
P5. The method of any of P1-P4, wherein:
   to predict target speech at a time window (t2-t3) comprises predicting said target speech before said target speech is generated.
P6. The method of any of P1-P5, wherein:
   to predict target speech at a time window (t2-t3) comprises predicting said target speech without recognizing a semantic meaning of the first portion of the electronic speech signal.
P7. The method of any of P1-P6, wherein the method is executed at a computer at which the verbal communication was generated.
P8. The method of any of P1-P7, wherein the method is executed at a third computer of a third-party user, remote from a computer at which the verbal communication was generated, to mitigate the risk of the third-party hearing the target speech.
P9. The method of any of P1-P8, wherein the method is executed at an intermediary computer system (e.g., in the cloud) electronically disposed between (i) a computer at which the verbal communication was generated and (ii) a computer in use by a third party, to mitigate the risk of the third-party hearing the target speech.
P10. The method of any of P1-P9, wherein each term in the pre-defined set of terms to be redacted is defined by a set of phones, and not based on a meaning of said term.
P11. The method of any of P1-P10, wherein the verbal communication comprises artificially-generated speech.
P12. The method of any of P1-P11, wherein the verbal communication comprises human speech uttered audibly by a human into a transducer.
P13. A computer-implemented system for moderating a verbal communication, the system comprising:
   a communications interface configured to receive, at a reception time (r1), an electronic speech signal of the verbal communication, said electronic speech signal of the verbal communication comprising a first portion at a first time (t1);
   an artificial intelligence trained to:
      (1) process said first portion of the electronic speech signal and thereby predict target speech at a time window (t2-t3), which time window (t2-t3) is subsequent to the first portion of the electronic speech signal, said target speech comprising a pre-defined set of terms to be redacted, and
      (2) redact said target speech from said electronic speech signal during said time window to produce a redacted verbal communication signal with less than 500 ms of introduced latency as measured from the reception time (r1); and
   a system output interface configured to provide the redacted audible communication signal as system output.
P14. The system of P13, wherein the communications interface comprises the system output interface.
P15. The system of any of P13-P14, wherein:
   to predict target speech at a time window (t2-t3) comprises predicting said target speech before said target speech is generated.
P16. The system of any of P13-P15, wherein:
   to predict target speech at a time window (t2-t3) comprises predicting said target speech without recognizing a semantic meaning of the first portion of the electronic speech signal.
P17. A non-transitory computer-readable medium storing computer-executable code thereon, the code when executed by a computer causing the computer to execute a process of moderating a verbal communication, the code comprising:
   code for causing the computer to receive, at a reception tie (r1) an electronic speech signal of the verbal communication, said electronic speech signal of the verbal communication comprising a first portion at a first time (t1);
   code for processing the electronic speech signal with an artificial intelligence, to:
      (1) process the first portion of the electronic speech signal and thereby predict target speech at a time window (t2-t3), which time window (t2-t3) is subsequent to the first portion of the electronic speech signal, said target speech comprising a pre-defined set of terms to be redacted, and
      (2) redact said target speech from said electronic speech signal during said time window to produce a redacted verbal communication signal with less than 500 ms of introduced latency as measured from the reception time (r1); and code for providing said redacted verbal communication signal to a consumer.
P18. The non-transitory computer-readable medium of P17, wherein code for processing the electronic speech signal with an artificial intelligence to predict target speech at a time window (t2-t3) comprises:
   code for predicting target speech before said target speech is generated.
P19. The non-transitory computer-readable medium of any of P17-P18, wherein code for processing the electronic speech signal with an artificial intelligence to predict target speech at a time window (t2-t3) comprises:
   code for predicting target speech before said target speech without recognizing a semantic meaning of the first portion of the electronic speech signal.
P20. The non-transitory computer-readable medium of any of P17-P19, wherein each term in the pre-defined set of terms to be redacted is defined by a set of phones, and not based on a meaning of said term.
P51. A computer-implemented method of moderating a verbal communication, the method comprising:
   receiving at the computer, at a reception time (r1), an electronic speech signal of the verbal communication, said electronic speech signal of the verbal communication comprising a first portion at a first time (t1);
   providing the electronic speech signal to an artificial intelligence, the artificial intelligence trained to:
      (1) process said first portion of the electronic speech signal and thereby predict target speech a time window (t2-t3), which time window (t2-t3) is subsequent to the first portion of the electronic speech signal, said target speech comprising a pre-defined set of terms to be redacted, and
      (2) redact said target speech from said electronic speech signal during said time window to produce a redacted verbal communication signal with less than 500 ms of introduced latency as measured from the reception time (r1); and providing said redacted verbal communication signal from the artificial intelligence to a consumer.
P52. The method of P51, wherein predict target speech a time window (t2-t3) comprises a prediction of a probability of target speech within said time window, which probability exceeds a threshold.
P53. The method of any of P51-P52, further comprising receiving, at the artificial intelligence, said pre-defined set of terms to be redacted.
P54. The method of P53, further comprising receiving, at the artificial intelligence from a user via a user interface, said pre-defined set of terms to be redacted.
P101. A computer-implemented method for automatically moderating a verbal communication, the method comprising:
   receiving at the computer, at a reception time (r1), an electronic speech signal of the verbal communication, said electronic speech signal of the verbal communication comprising a first portion at a first time (t1);
   providing an artificial intelligence trained to process the electronic speech signal based on a set of rules, the rules defining target speech by a set of phones and/or phonemes, the artificial intelligence configured to:
      (i) predict, based on the rules and as a function of phones or phonemes in the electronic speech signal, target speech at a time window (t2-t3), which time window (t2-t3) begins subsequent to the first time (t1), and to
      (ii) redact said target speech from said electronic speech signal during said time window to produce a redacted verbal communication signal with less than 500 ms of introduced latency; and
   predicting, via the artificial intelligence and based on the rules and as a function of phones or phonemes in the electronic speech signal, target speech at a time window (t2-t3), which time window (t2-t3) begins subsequent to the first time (t1), and
   redacting said target speech from said electronic speech signal during said time window to produce a redacted verbal communication signal with less than 500 ms of introduced latency; and
   providing said redacted verbal communication signal from the artificial intelligence to a consumer.
P102. The method of P101, further comprising receiving, at the artificial intelligence, definition of said target speech as a pre-defined set of terms to be redacted.

Various embodiments of this disclosure may be implemented at least in part in any conventional computer programming language. For example, some embodiments may be implemented in a procedural programming language (e.g., “C”), or in an object-oriented programming language (e.g., “C++”), or in Python, R, Java, LISP or Prolog. Other embodiments of this disclosure may be implemented as preprogrammed hardware elements (e.g., application specific integrated circuits, FPGAs, and digital signal processors), or other related components.

In an alternative embodiment, the disclosed apparatus and methods may be implemented as a computer program product for use with a computer system. Such implementation may include a series of computer instructions fixed either on a tangible medium, such as a non-transitory computer readable medium (e.g., a diskette, CD-ROM, ROM, FLASH memory, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of this disclosure may be implemented as a combination of both software (e.g., a computer program product) and hardware. Still other embodiments of this disclosure are implemented as entirely hardware, or entirely software.

Computer program logic implementing all or part of the functionality previously described herein may be executed at different times on a single processor (e.g., concurrently) or may be executed at the same or different times on multiple processors and may run under a single operating system process/thread or under different operating system processes/threads. Thus, the term “computer process” refers generally to the execution of a set of computer program instructions regardless of whether different computer processes are executed on the same or different processors and regardless of whether different computer processes run under the same operating system process/thread or different operating system processes/threads.

The embodiments of the invention described above are intended to be merely exemplary; numerous variations and modifications will be apparent to those skilled in the art. Such variations and modifications are intended to be within the scope of the present invention as defined by any of the appended claims.

What is claimed is:

1. A computer-implemented method of moderating a verbal communication, the method comprising:
receiving at the computer, at a reception time (r1), an electronic speech signal of the verbal communication, said electronic speech signal of the verbal communication comprising a first portion at a first time (t1);
providing the electronic speech signal to an artificial intelligence, the artificial intelligence configured to:
(1) process said first portion of the electronic speech signal and thereby predict target speech a time window (t2-t3), which time window (t2-t3) is subsequent to the first portion of the electronic speech signal, said target speech comprising a pre-defined set of terms to be redacted, and
(2) redact said target speech from said electronic speech signal during said time window to produce a redacted verbal communication signal with less than 500 ms of introduced latency as measured from the reception time (r1);
producing the redacted verbal communication signal using the artificial intelligence; and
providing said redacted verbal communication signal from the artificial intelligence to a consumer.

2. The method of claim 1, wherein receiving an electronic speech signal of verbal communication comprises receiving acoustic spoken speech at a transducer and converting said acoustic spoken speech to said electronic speech signal.

3. The method of claim 2, wherein the transducer comprises a microphone.

4. The method of claim 1, wherein redacting said target speech from said electronic speech signal during said time window to produce the redacted verbal communication comprises:
muting the electronic signal during said time window.

5. The method of claim 1, wherein:
to predict target speech at a time window (t2-t3) comprises predicting said target speech before said target speech is generated.

6. The method of claim 1, wherein:
to predict target speech at a time window (t2-t3) comprises predicting said target speech without recognizing a semantic meaning of the first portion of the electronic speech signal.

7. The method of claim 1, wherein the method is executed at a computer at which the verbal communication was generated.

8. The method of claim 1, wherein the method is executed at a third computer of a third-party user, remote from a computer at which the verbal communication was generated, to mitigate the risk of the third-party hearing the target speech.

9. The method of claim 1, wherein the method is executed at an intermediary computer system (e.g., in the cloud) electronically disposed between (i) a computer at which the verbal communication was generated and (ii) a computer in use by a third party, to mitigate the risk of the third-party hearing the target speech.

10. The method of claim 1, wherein each term in the pre-defined set of terms to be redacted is defined by a set of phones, and not based on a meaning of said term.

11. The method of claim 1, wherein the verbal communication comprises artificially-generated speech.

12. The method of claim 1, wherein the verbal communication comprises human speech uttered audibly by a human into a transducer.

13. A computer-implemented system for moderating a verbal communication, the system comprising:
a communications interface configured to receive, at a reception time (r1), an electronic speech signal of the verbal communication, said electronic speech signal of the verbal communication comprising a first portion at a first time (t1);
an artificial intelligence configured to:
(1) process said first portion of the electronic speech signal and thereby predict target speech at a time window (t2-t3), which time window (t2-t3) is subsequent to the first portion of the electronic speech signal, said target speech comprising a pre-defined set of terms to be redacted, and
(2) redact said target speech from said electronic speech signal during said time window to produce a redacted verbal communication signal with less than 500 ms of introduced latency as measured from the reception time (r1); and
a system output interface configured to provide the redacted audible communication signal as system output.

14. The system of claim 13, wherein the communications interface comprises the system output interface.

15. The system of claim 13, wherein:
to predict target speech at a time window (t2-t3) comprises predicting said target speech before said target speech is generated.

16. The system of claim 13, wherein:
to predict target speech at a time window (t2-t3) comprises predicting said target speech without recognizing a semantic meaning of the first portion of the electronic speech signal.

17. A non-transitory computer-readable medium storing computer-executable code thereon, the code when executed by a computer causing the computer to execute a process of moderating a verbal communication, the code comprising:
code for causing the computer to receive, at a reception tie (r1) an electronic speech signal of the verbal communication, said electronic speech signal of the verbal communication comprising a first portion at a first time (t1);
code for processing the electronic speech signal with an artificial intelligence, to:
(1) process the first portion of the electronic speech signal and thereby predict target speech at a time window (t2-t3), which time window (t2-t3) is subsequent to the first portion of the electronic speech signal, said target speech comprising a pre-defined set of terms to be redacted, and
(2) redact said target speech from said electronic speech signal during said time window to produce a redacted verbal communication signal with less than 500 ms of introduced latency as measured from the reception time (r1);
code for causing the artificial intelligence to produce the redacted verbal communication signal; and
code for providing said redacted verbal communication signal to a consumer.

18. The non-transitory computer-readable medium of claim 17, wherein code for processing the electronic speech signal with an artificial intelligence to predict target speech at a time window (t2-t3) comprises:
code for predicting target speech before said target speech is generated.

19. The non-transitory computer-readable medium of claim 17, wherein code for processing the electronic speech signal with an artificial intelligence to predict target speech at a time window (t2-t3) comprises:
code for predicting target speech before said target speech without recognizing a semantic meaning of the first portion of the electronic speech signal.

20. The non-transitory computer-readable medium of claim 17, wherein each term in the pre-defined set of terms to be redacted is defined by a set of phones, and not based on a meaning of said term.
